(19) United States
(12) Patent Application Publication
(10) Pub. No.: US 2006/0107062 A1
(43) Pub. Date: May 18, 2006

(54) Portable personal mass storage medium and information system with secure access to a user space via a network

(76) Inventor: David Fauthoux, Ramonville Saint Agne (FR)

Correspondence Address: YOUNG & THOMPSON, 745 SOUTH 23RD STREET, 2ND FLOOR, ARLINGTON, VA, 22202, US

(21) Appl. No.: 11/280,347

(22) Filed: Nov. 17, 2005

Related U.S. Application Data
(60) Provisional application No. 60/632,073, filed on Dec. 1, 2004.

(30) Foreign Application Priority Data
Nov. 17, 2004 (FR) 04.12199

(51) Int. Cl. H04L 9/00; H04K 1/00

(52) U.S. Cl. 713/182

(57) ABSTRACT

The invention relates to a portable mass storage, so-called personal medium (1), comprising a personal mass storage in which data are recorded, and forming a gateway process (P) capable of being loaded in the random access memory of a host station (5), and of being able to configure this host station (5) to which the personal medium (1) is connected. The invention covers an information system comprising personal media (1), host stations (5), and servers (9) on which is recorded information corresponding to user spaces belonging to the titular users of the personal media (1).

The present invention relates to a portable personal mass storage medium and an information system enabling each user equipped with such a personal medium to access in a secure manner a user information space that belongs to him/her, via a network such as the Internet, from any host information station that has not been specifically configured or dedicated beforehand to manage this user space or permit access to this user space.

Various known systems propose using a personal medium such as a USB (Universal Serial Bus) key in order to control the access of a user to a computer, or more generally to information sources, by one or more passwords (symmetric key(s)) recorded in encrypted form on the medium. There may be mentioned by way of examples the SECURIKEY® or WIBU-KEY® systems (marketed by WIBU-SYSTEMS, Karlsruhe, Germany). These systems do not however allow a user to access information sources in a personalised manner (user space) which can include documents, files, data, programs, etc. from any computerized station that has not previously been configured to this end and connected to a network.

Moreover, with these known systems all the identity verification or authentication means, including the software, are stored on the key, so that access to the personal information sources is impossible for a user who has lost his/her personal medium. On the other hand, a third party in possession of the personal medium can access these sources if he/she can re-read the password or passwords from the medium, which technically is not impossible.

US-2004/0001088 describes a portable device such as a USB key enabling the personal information environment to be transferred from a user, in the form of files stored on the non-volatile memory of this USB key. This personal environment contains favorites, electronic mail, contacts, “cookies” (web user data), digital signatures, screen backgrounds, desktop icons, calendars/timetables and agendas, toolbar configurations, audio and graphical configurations, game options, etc. This environment may be defined by remote loading from an Internet site whose address is stored on the USB key. This system thus consists in using the memory of the USB key to transfer an information environment from one computer to another. However, to do this each computer must be compatible with such an environment and must be independently and previously programmed to be able to execute the transfer of the personal environment from information contained on the portable medium. Accordingly this document does not describe an information system permitting access to a user space contained in whole or in part on a device other than its personal computers and the personal medium, and moreover from any station initially not specifically configured for such an access.

In addition, other solutions (for example US-2002/0133561) have proposed creating a virtual disk on the Internet for the remote storage, extraction, access, control and manipulation of files by a user from any terminal. However, access to this virtual disk assumes that the terminal used has itself previously been configured to permit this access, contains a part of the user space, and is compatible with the technology and operating system used to store the remote files. In particular, each terminal should be equipped with an Internet browser compatible with the technology used to create the virtual disk.

Thus, all the previously proposed solutions for the management of a personal user space managed on a network (and not on a specific information site) encounter the problem that they are strictly dependent on the operating system on which they are based and on the specific practical implementation that they require (programming and/or storage architecture of the data and/or specific technologies). However, the various information sources that may comprise a user space are nowadays extremely varied and are not necessarily compatible with the programming techniques, architectures, applications or the operating systems required in the known solutions.

Thus, any known solution does not permit a user to access instantaneously a user space that may include not only personal data and information, but also data or information shared by other users, applications stored in executable form, this user space being remotely managed on one or more servers, and moreover from any information station not previously configured or adapted for this purpose and possibly not containing any digital information (programs or data) corresponding to this user space.

The object of the invention is in general to provide a solution to this problem.

The invention thus aims to provide a portable mass storage medium and an information system by means of which a user can access a personal dedicated user information space from any information station not specifically configured beforehand for this purpose and that may itself not contain any digital information (programs or digital data) corresponding to this user space.

The invention also aims to permit such an access in a secure manner, but without the loss of the personal medium then making it impossible to access the user space, or simply the possession of the personal medium enabling access by a person other than the authorised user.

The invention aims in addition to provide such a personal medium and such an information system by means of which the information of the user space is automatically updated and synchronised, without the risk of loss of data, in a reliable manner, including the case of a sudden breakdown in connection between a station and the network.

The invention aims furthermore to provide an information system that is efficient in terms of reaction speed for the user, is simple and ergonomic to use, and has a low cost price.

The following terminology is adopted throughout the text:
mass storage: any rewriteable non-volatile information memory that enables digital information to be stored in a permanent manner regardless of the implementation technology (magnetic, optical, electronic, etc.) used to record it,
information system: combination of hardware, software, information, data files and/or databases, digital data, capable of implementing predetermined information functions,
user: a physical person or legal entity or a group of physical people and/or legal entities,
portable: denotes any object that can be handled by a person, carried in one hand, and transported easily and permanently, for example in a handheld format,
file: this term is used in its logical meaning and denotes a set of digital information identified by a digital address; it may involve for example one or more physical files or one or more tables of data or part of a physical file or of a table of data,
user space: set of information sources, data, software or other information capable of providing information services belonging to a predetermined user, including the recording of specific information belonging to a user and making predetermined data and software available to this user; the user space includes not only data or information created or managed by a user, but also data, information and programs in executable form shared by other users or suppliers of information sources.

The present invention thus relates to a portable mass storage medium, so-called personal medium, comprising:
at least one mass storage, so-called personal storage,
means for connection to any information station, so-called host station, equipped with
   digital processing means involving microprocessor(s) and associated random access memory(ies),
   at least one file operating and management system,
   connection means corresponding to those of the personal medium, so that at least a part of the personal memory of the personal medium can be accessed by reading/writing by a host station when the connection means are active,
data, so-called user identification data, recorded in said personal memory for identifying at least one human user, so-called authorised user, who is authorised to use this personal medium,
   wherein it includes, recorded in said personal memory, data forming a process, so-called gateway process, capable of being loaded in random access memory of a host station to which the personal medium is connected, this gateway process comprising:
an authentication module capable of enabling any host station to authenticate any human user making the connection from this personal medium to this host station, said authentification module being capable of determining whether said human user is an authorised user, and of authorising access to a user space corresponding to the user identification data recorded in the personal memory only if an authorised user is identified and authenticated, said user space comprising digital information recorded in a part, so-called local cache, of said personal memory and/or in at least one mass storage of at least one server different from said host station and to which said host station, provided with connection and access means to at least one digital network, may be connected via such a network,
a file request module, capable of recognising any request involving at least one file, so-called KEY file, belonging to said user space of said authorised user,
a processing module for processing each request involving a KEY file, and capable of creating a KEY file and/or accessing any KEY file and permitting the processing of a corresponding request by the file operating and management system of said host station in the same way as if it were a request involving a file belonging to said host station.

The invention covers an information system for safe access to a network by users, comprising:
information stations, so-called host stations, each equipped with:
   digital processing means using associated microprocessor(s) and associated random access memory(ies),
   at least one file operating and management system,
   connection means corresponding to connection means of at least one portable personal mass storage medium, so-called personal medium, so that at least part of mass storage of said personal medium can be accessed by reading/writing by said host station when said connection means are active,
   connection and access means to at least one public digital network, in particular the Internet,
at least one server comprising at least one mass storage, so-called server memory, and connection means to at least one public digital network, in particular the Internet, and capable of permitting access by writing/reading to at least a part of this server memory via such a public digital network,
each personal medium comprising:
   at least one mass storage, so-called personal memory,
   connection means to any host station,
   data, so-called user identification data, recorded in said personal memory, for identifying at least one human user, so-called authorised user, who is authorised to use this personal medium,
      wherein each personal medium comprises, recorded in said personal memory, data forming a process, so-called gateway process, capable of being loaded into the random access memory of a host station to which the personal medium is connected, this gateway process comprising:
an authentification module capable of enabling any host station to authenticate any human user making a connection from this personal medium to this host station, and capable of determining whether said human user is an authorised user, and of authorising access to a user space corresponding to the user identification data recorded in the personal memory only if an authorised user is identified and authenticated, said user space comprising digital information recorded in a part, so-called local cache, of said personal memory, and/or in at least a server memory of at least one server distinct from the host station,
a file request filtering module, capable of recognising any request involving at least one file, so-called KEY file, belonging to said user space of the authorised user,
a processing module for processing each request involving a KEY file capable of creating a KEY file and/or accessing any KEY file and permitting the processing of a corresponding request by the file operating and management system of the host station in the same way as if it were a request involving a file belonging to this host station.

An information system according to the invention thus constitutes an information system with secure access by users to user spaces via a network—in particular a public network such as the Internet. Each user space belongs to a single user and contains files that may be entirely managed and used by the user, thanks in particular to the gateway process.

An information system according to the invention comprises a number of personal media corresponding to the number of users of the system. Any portable mass storage medium may be used as personal medium according to the invention. This may involve in particular mass storage media of magnetic, optical, electronic, electro-optical, etc. type, the invention not being restricted to a specific technology for the realisation of the personal media. It should be noted however that the personal medium contains at least one mass storage, which is thus in particular of the rewriteable type, accessible by reading and by writing. In this connection, a specific feature of the invention consists in providing an extremely high level of security as regards in particular the information of each user space, by employing rewriteable personal media.

In an information system according to the invention each user is provided with his/her own dedicated personal medium, and the different users may be provided with personal media all implemented according to the same technology or, on the other hand, according to different technologies. There is also nothing to prevent the same portable personal medium from incorporating several mass storages of different technologies, the information and data contained on this personal medium being duplicated in these different mass storages, in such a way that the personal medium is compatible with different connection technologies to the host stations.

The personal media may be more or less complicated and in particular may themselves incorporate means for the digital processing of data, such as a microprocessor or the like. However, advantageously and according to the invention, the personal media are free of digital processing means other than those that are necessary, where applicable, for the establishment and functioning of the means of connection between the personal media and the host stations.

The personal media may in particular not include a microprocessor, associated random access memory, or any polyfunctional unit for processing information and/or calculation tasks. Advantageously and according to the invention, they are also free of a human-machine interface (screen, keyboard, pointing device, etc.), but the host stations are provided with a human-machine interface. The personal medium may thus be reduced simply to the elements forming their mass storage functions and standard connection to a host station.

The connection means between the personal media and the host stations may be realised in all known forms, including in particular a wired connection, a radio frequency or infrared remote control connection, a connection involving inserting the personal medium into an appropriate reader (for example if the personal medium is a cassette, a tape, a diskette or a floppy disk). Advantageously and according to the invention, the connection means between a personal medium and a host station are of the type that are made active by bringing together and/or connecting the personal medium and the host station. According to one embodiment, a personal medium according to the invention may advantageously be realised in the form of a simple USB key, thereby enabling the investment cost to be reduced to the absolute minimum for each user.

The invention can also be applied however to more sophisticated personal media (such as portable personal digital assistants (PDA) or portable computers or mobile phones with mass storage, etc.), thereby enabling information processing means involving microprocessor(s) and/or a human-machine interface to be incorporated; in this case however these information processing means are of no use in the context of the present invention. The human-machine interface of such a medium can replace in part or in whole that of a host station.

Types of connection other than a USB connection may be envisaged, as a variant or in combination, for example a wired connection or a radio frequency (WI-FI or other) or infrared wireless-type connection.

Whatever the case, each user equipped with a personal medium can access his/her user space from any host station to which the user can connect his/her personal medium. The invention thus provides a simple, rapid and roaming access by each user to his/her user space.

In addition, advantageously and according to the invention, a system according to the invention comprises ROOT_ID data recorded in the personal memory of each personal medium and identifying at least one root file recorded on a server, this root file including at least a part of the architecture of the KEY files of the user space. As a result this part of the architecture or this architecture is not necessarily itself stored on the personal media (except possibly duplicated in the local cache of the personal medium) nor on the host stations. It should also be noted that other KEY files of the user space may contain, in the same way, part of the architecture of the user space. In other words, the data describing the architecture of the user space are not necessarily collected together in one and the same root file, but may be distributed among several files, namely one (or more) root files specifically dedicated to the recording of these data and/or one (or more) KEY files that may contain other information or data.

According to the invention, this root file is preferably a KEY file (that is to say a file of the corresponding user space) and is managed as such.

Furthermore, advantageously in an information system according to the invention the host stations are chosen from:
fixed (desktop) personal computers,
portable personal computers
portable digital processing devices, in particular personal digital assistants or mobile phones.

The host stations may be any such stations and may be more or less sophisticated, as long as they allow the provision of means for processing information and managing files and, preferably, at least in part, the human-machine interface. For each user these host stations may therefore be the user's desktop personal computers located at the user's home and place of work, the user's portable computer, a personal digital assistant, access terminals to the Internet accessible by the public (such as those available in public places such as stations, airports, media centres, shopping malls, cybercafés, etc.) or a computer or personal assistant belonging to a friend or colleague. By virtue of the invention each user thus has instantaneous access to the set of application files, data and programs of his/her user space from any location whatsoever, without specifically having to configure a computer manually beforehand (in particular without having to install software or an operating system on the host station beforehand), and this simply by means of his/her personal medium, in a perfectly secure manner. The result is an extremely high level of management convenience for the users at a negligible cost.

Such a storage architecture and secure network access to user spaces has numerous other advantages associated with the complete revolution in the practices and methods of modern information processing technologies provided by the invention. In particular, the various updating and development of data and/or applications may be carried out directly on the servers by the suppliers of these data and/or applications themselves, and do not require any intervention (such as for example a remote loading and/or an installation) on the part of each user. Moreover, the implementation and use of the invention are not dependent on a particular operating system or a particular technology. In fact, the invention may be made compatible (as described hereinafter) with all the operating systems proposed by the editors or constructors. The files of the user space are viewed and managed from any host station just like files belonging to this host station. Consequently, the software applications proposed by the editors or constructors under these operating systems function unmodified with the files of the user space. This universal and systematic aspect of the invention is valuable in terms of ergonomics and is extremely attractive for the users and editors.

Thus, advantageously and according to the invention the processing module is capable of being implemented in a storage region dedicated to the applications and accessible in user mode of the random access memory of a host station.

Furthermore, advantageously and according to the invention the authentication module is capable of authenticating an authorised user by the latter's inputting at a human-machine interface—in particular at the human-machine interface of the host station to which the personal medium is connected—a code, so-called personal user code, enabling the identity of the user to be validated by the authentication module, and of storing the personal user code in the random access memory of the host station, and the gateway process is capable of transmitting the personal user code to each server to which the host station is connected in order to transmit digital information. This personal user code may be a user password input on a keyboard, for example the keyboard of a host station, or a digital code representative of a biometric characteristic (digital imprint) acquired by a sensor that is part of a host station or a personal medium, or other means.

Since the personal user code is not recorded on the personal medium, the loss or theft of the latter is not vital to the user, who will be able to re-access his/her user space with another personal medium.

Advantageously and according to the invention, each server is capable of verifying the validity of the personal user code before authorising the setting up of a connection between the server and a host station to which a corresponding personal medium is connected.

In addition, advantageously an information system according to the invention comprises at least one server, so-called central server, containing for each user at least one record, so-called user account, containing the said user identification data associated with the personal user code stored in the said record in a form that cannot be understood by a person. Advantageously and according to the invention, the said user identification data recorded in the personal memory of a personal medium include a code identifying individually a user, and data identifying a central server.

Advantageously and according to the invention, the processing module includes at least one encryption sub-module for encryption with a symmetric key generated by the processing module from a code provided by the processing module.

Moreover, advantageously and according to the invention each personal medium comprises, recorded in the personal memory, an asymmetric public encryption key corresponding to a private key of a central server, this private key being stored in a mass storage of the central server, and the processing module is capable of:
generating a symmetric key and encrypting the latter with the said public key,
transmitting this encrypted symmetric key to the central server, which is itself capable of unencrypting it (with the corresponding private asymmetric key),
encrypting the user identification data and the personal user code with the said symmetric key before transmitting them to the central server.

In addition, in an advantageous embodiment of the invention the processing module is capable of recording, by default, any KEY file of the user space that is the subject of a digital processing by the host station in the local cache of the personal memory of the personal medium. In this way the operations carried out by the user during a working session are saved in the local cache of the personal medium, and are preserved even in the case of a sudden breakdown in the connection to the public network or the connection between the personal medium and the host station.

In addition and advantageously, in an information system according to the invention the KEY files are identified by a low level identifier compatible with all the operating systems and the file management systems, and all the servers, all the host stations (and their file management system or systems), and all the personal media. Thus, advantageously and according to the invention, the processing module is capable of creating each KEY file with a record identifying this KEY file, so-called INFO_ID, comprising:
a code identifying a server, so-called FILESERV_ID, where this file was initially recorded,
a code identifying a user who has created this KEY file,
a digital code identifying individually the KEY file.

Advantageously and according to the invention, an INFO_ID record also comprises:
a code defining an encryption mode for the KEY file,
a code defining a synchronisation mode for the KEY file.

The encryption mode may be chosen from: an encryption, so-called automatic encryption, with a symmetric key; an encryption, so-called manual encryption, by a code input specifically by the user for the KEY file; and the absence of encryption. This encryption mode can be defined automatically during the generation of the files, for example by means of a configuration file that associates the encryption modes with names or parts of names of files, this configuration being able to be modified by the user.

The synchronisation mode determines the way in which the KEY file is updated on a server. This synchronisation mode may be chosen from: a mode, so-called synchronised mode, in which a KEY file is read from the local cache if it exists there and is updated, and from the server if this is not the case, and in any case the KEY file is written in the local cache, the processing module comprising a sub-module for the automatic updating of the FILESERV_ID server when the connections are live; and a mode, so-called remote mode, in which any reading and writing of a KEY file are carried out only from and on the corresponding FILESERV_ID server. The remote mode is used for example for the user identification data, or for command files, or for KEY files that the user does not wish to keep in a local cache.

Advantageously and according to the invention, each personal medium comprises, recorded in the personal memory, a file, so-called ID_GENERATION file, comprising data capable of allowing the processing module to generate digital codes identifying individually the KEY files created by the user.

The invention in addition relates to a personal medium and an information system characterized in combination by all or some of the characteristics mentioned above or hereinafter.

Other aims, characteristics and advantages of the invention will appear on reading the following description of one of the embodiments thereof given by way of non-limiting example, and with reference to the accompanying drawings in which:

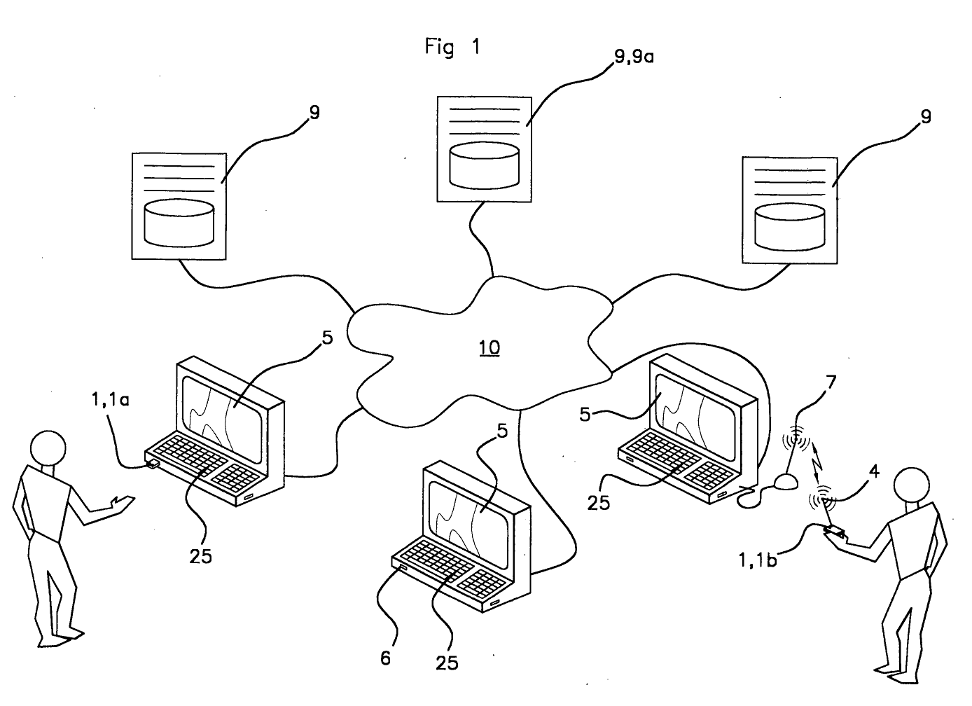

FIG. 1 is a general diagram of an information system according to the invention,

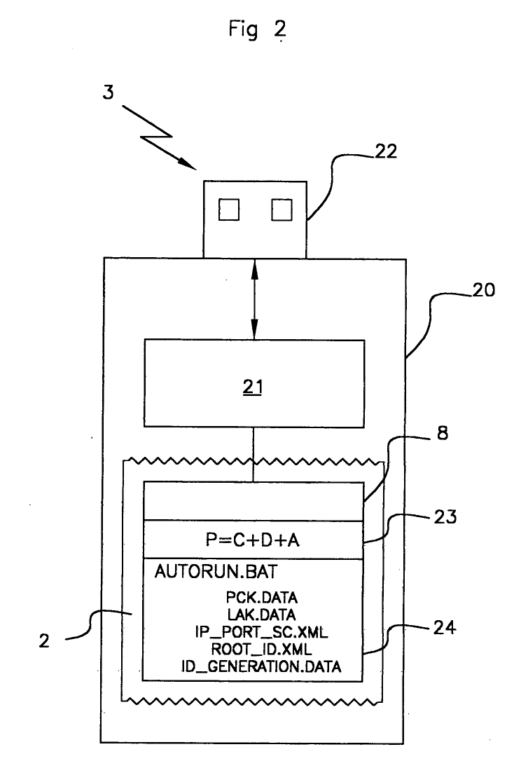

FIG. 2 is an overall diagram of an example of implementation of a personal medium according to the invention in the form of a USB key,

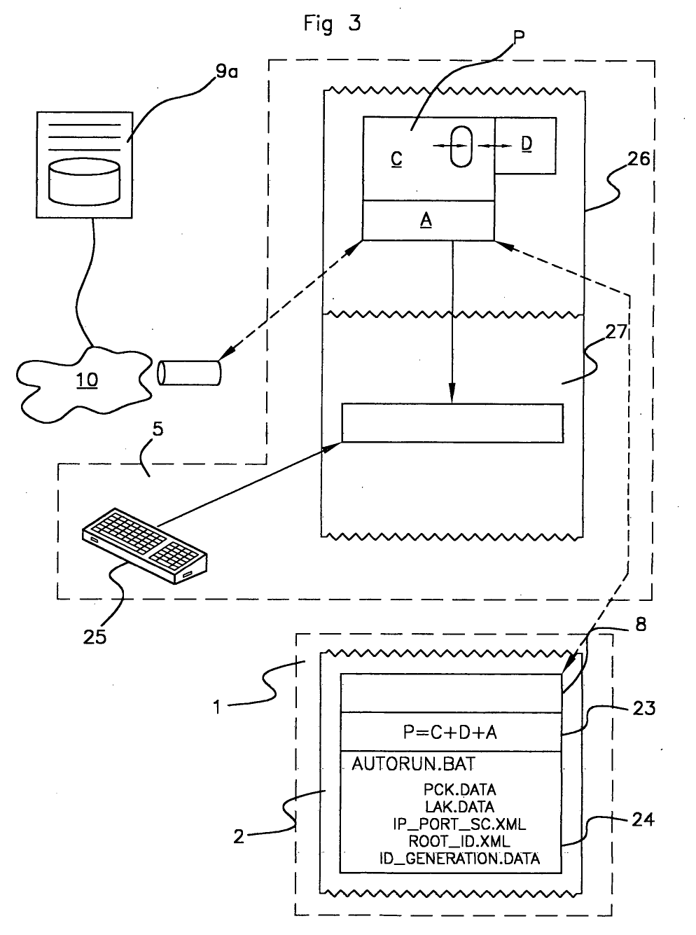

FIG. 3 is a diagram illustrating the functioning of a personal medium according to the invention and of a host station in an information system according to the invention,

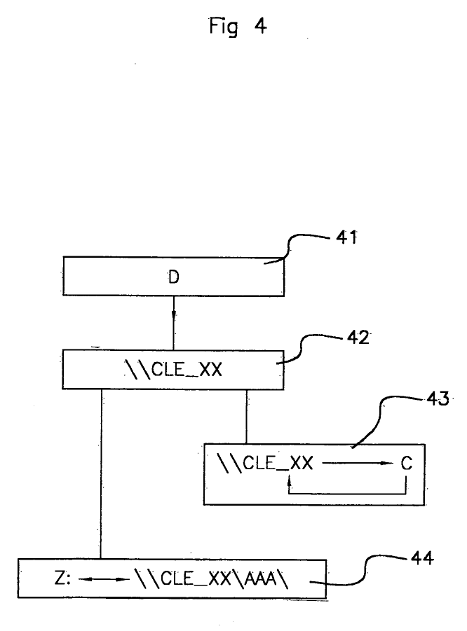

FIG. 4 is a flow chart illustrating stages of referencing a personal medium according to the invention in the file management system of a host station,

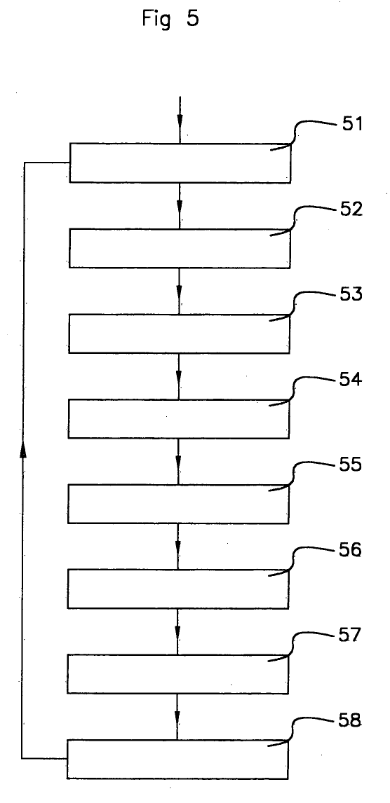

FIG. 5 is a flow chart illustrating stages of managing requests for KEY files of a user space corresponding to a personal medium according to the invention in an information system according to the invention,

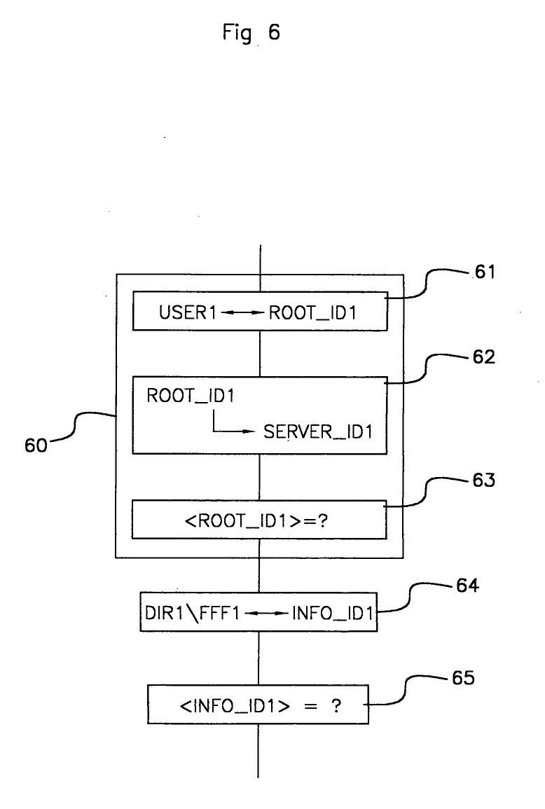

FIG. 6 is a flow chart illustrating stages involved in a request to read a KEY file of a user space corresponding to a personal medium according to the invention in an information system according to the invention,

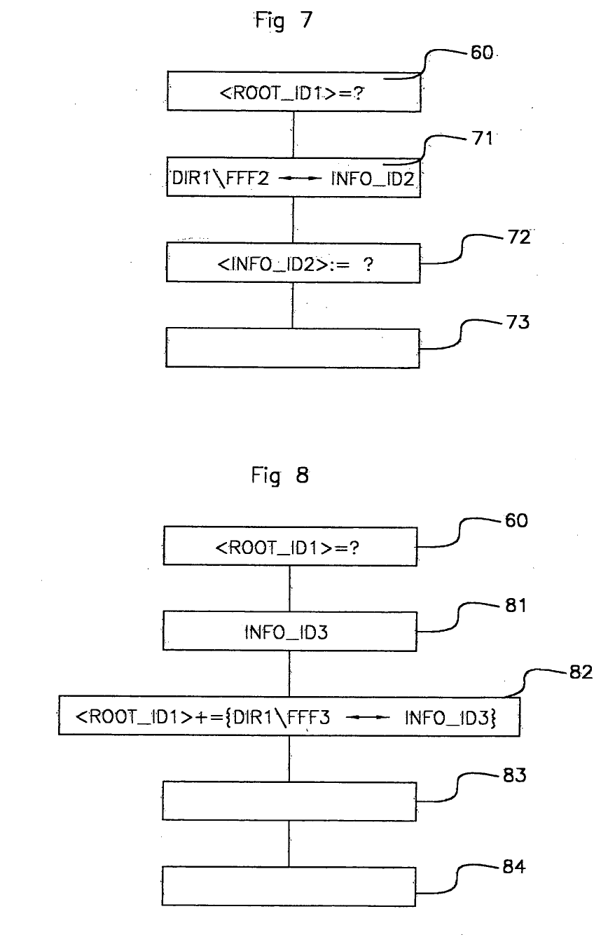

FIG. 7 is a flow chart similar to FIG. 6, illustrating stages involved in a request to write on a KEY file of the user space,

FIG. 8 is a flow chart similar to FIG. 6, illustrating stages involved in the creation of a new KEY file in the user space.

As shown in FIG. 1, the information system according to the invention constitutes an information architecture for network storage of personal information permitting secure access to such personal information by any authorised and authenticated user who has a portable mass storage medium, so-called personal medium 1, that belongs to the user.

Such a personal medium 1 according to the invention comprises at least one mass storage, so-called personal memory 2, which may be realised in all known forms, in particular in the form of an electronic and/or magnetic hard disk and/or optical disk or other means. This personal memory 2 has the property that it saves in a permanent manner between two uses the information recorded in this personal memory 2, in particular when the personal medium 1 is carried by a user.

Each personal medium 1 moreover comprises means 3, 4 for connection to any information station, so-called host station 5, which is itself provided with digital processing means involving associated microprocessor(s) and random access memory(ies) and at least one file operation and management system. Each host station is also provided with connection means 6, 7 combined with those of the personal medium 1, so that at least a part of the personal memory 2 of each personal medium 1 can be accessed by reading and by writing by a host station 5 when the connection means 3, 4, 6, 7 are active.

Thus, each personal medium 1 may be connected to any host station 5, allowing the user to carry out, from this host station 5, operations on an information user space that belongs to him/her, including information and/or files representing data and/or software, stored on remote machines such as servers 9 different from the host stations 5 and personal media 1. Of course, there is also nothing to prevent all or part of the user space being recorded on the personal medium 1 of the user. Neither is there anything to prevent a host station 5 acting as storage server for all or part of a user space. Nevertheless, in general the different host stations 5 to which a given user may be connected from his/her personal medium 1 in order to carry out operations on his/her user space are not servers, and it is not necessary nor in general useful to record all or part of the information of the user space on a mass storage of a host station 5.

The personal medium 1 may, as shown in FIG. 1, be a USB (Universal Serial Bus) key 1a or a portable device 1b communicating by radio frequency with a host station (this may be a mobile phone or a so-called PDA type Digital Personal Assistant with wireless type connection, or a card with an electronic memory provided with wireless type connection means, for example of the so-called Wi-Fi type, etc.).

Any other portable device may be used and envisaged as personal medium 1 according to the invention so long as this portable device can easily be carried by a user (handheld format), and so long as it is provided with a mass storage and means for connection to the host stations. Such a personal medium 1 may also be provided with other functionalities, and in particular with means for processing information or means for satellite communication or mobile telephony, etc. Nevertheless, it is an advantage of the invention that it enables low cost price personal media 1 such as USB keys or simple electronic cards to be distributed in order to allow the users to access their user space. Such personal media 1 in their simplest form are not only inexpensive but are light and compatible with very many information standards that may be encountered in the host stations 5 distributed over the territory.

In general, the personal medium 1 is not provided with a human-machine interface (screen, keyboard, etc.). Instead, a host station 5 is generally equipped with such a human-machine interface. However, the invention is of course applicable in the case where at least some of the various personal media 1 are equipped with such a human-machine interface. In this latter case the user may alternatively use either the human-machine interface of his/her personal medium 1, or that of a host station 5 which the user encounters and to which he/she is connected.

Thus, any host station 5 equipped with connection means compatible with those of a personal medium 1, with information processing means and with a connection to a public digital network such as the Internet may be used by a user in order to access his/her user space. Such host stations 5 are encountered very frequently in various public or private locations. This may include various of the user's personal computers (in the office, at home, etc.); computers that the user may encounter in the places that he/she visits (clients, suppliers, friends, etc.); or even public access sites (Internet access terminals in airports, stations, restaurants or cafés, etc.).

According to the invention, even if a part of the user space may be stored at least temporarily on a personal medium 1 of the user, in general all the information corresponding to a user space is stored on remote servers 9 that are remotely accessible via a public digital network such as the Internet from any host station 5 connected to this network.

Thus, in a system according to the invention the personal information of the user is not all stored on the personal medium 1 or on a host station 5 to which this personal medium 1 is connected. In a further development of the invention the totality of the information of the user space is stored solely on remote servers 9 and not on the personal medium 1 or on the host station 5, with the exception of the most recent information that has not yet been synchronised with that stored on the servers 9 and which may be recorded temporarily solely on the personal medium 1, in a part of the personal memory 2 reserved for this purpose, so-called local cache 8, accessible by reading and writing.

Each personal medium 1 moreover includes data, so-called user identification data, for identifying at least one human user, so-called authorised user, who is allowed to use the corresponding personal medium 1, and these identification data are recorded in the personal medium 2.

According to the invention each personal medium 1 comprises data recorded in the personal memory that form a process, so-called gateway process P, which is capable of being loaded into the random access memory of any host station 5 to which the personal medium 1 is connected, and of configuring this host station 5 so as to allow the user to access his/her user space.

This gateway process P basically and functionally comprises three modules (these three modules may be realised in the form of independent programs or sub-programs or, alternatively, are integrated in the same program), namely:
an authentication module A for the authentication by each host station 5 of any human user making the connection from a personal medium 1 to this host station 5, this authentication module A being capable of determining whether the user is an authorised user and of authorising access to the user space corresponding to the user identification data recorded in the personal memory of the personal medium 1 only if a corresponding authorised user is identified and authorised; the object of this authentication module A in its simplest embodiment is to manage a personal user code (such as a user password) entered by the user at a human-machine interface (for example that of the host station 5), and then to verify whether the personal user code is the right code during each entry of this code by the user,
a module D for filtering requests for files, capable of being able to recognise any request involving at least one file, so-called KEY file, belonging to a user space of the authorised user,
a module C for processing each request for a KEY file, capable of being able to create a KEY file and/or access any KEY file (by reading and/or by writing) and to permit the processing of a corresponding request by the file operating and managing system of the host station 5, in the same way as if this were a request for a file belonging to this host station 5.

A personal medium 1 according to the invention may thus be free of digital processing means other than those necessary, where appropriate, for the establishment and functioning of the connection means 3, 4, 6, 7 to the host stations 5. In particular, a personal medium 1 according to the invention may be free of a microprocessor and associated random access memory or, more generally, of a central calculation and information processing unit. Likewise, as mentioned above, a personal medium 1 according to the invention may be free of a human-machine interface.

According to the invention the user identification data constitute only a part of all the data permitting the authentication of an authorised user by the authentication module A carried out by a host station 5. In other words, these user identification data stored in the personal memory 2 of the personal medium 1 are designed to be insufficient to allow a user to access his/her user space. This is an important difference of the invention compared to prior art devices, in which a user can access information sources simply by connecting a USB key to a computer connected to these information sources. In contrast to this, according to the invention a user who has a personal medium 1 should, in order to be able to access his/her user space, not only connect his/her personal medium 1 to any host station 5, but should also provide additional authentication information, namely the personal user code, which the user must input at the human-machine interface at his/her disposal, in particular that of the corresponding host station 5.

If a user loses his/her personal medium 1 or it is stolen, the new holder of the personal medium 1 will not be able to access the user space of the initial authorised user. Conversely, the true authorised user will easily be able to re-access his/her user space by acquiring a new simple personal medium 1 containing the user identification data, which can be manufactured and supplied to the true user on the basis of the identification data of the user's account recorded in his/her user space.

The personal user code is used by the authentication module A to validate the identity of the authorised user. The code may be a user password entered by the user on a keyboard (for example the keyboard 25 of a host station 5). However, it may also be any other code that can be supplied by the user, for example a digital code representative of a biometric characteristic, issued by a sensor that may be integral with the host station 5 or with the personal medium 1. For example the personal medium 1 may be provided with a digital print sensor or other sensor. It should be noted however that in any case the validation of the identity by means of the personal user code is carried out by the authentication module A and executed by the host station 5, and not by an electronic circuit of the personal medium 1.

The said connection means 3, 4, 6, 7 between a personal medium 1 and a host station 5 are made active by bringing together the personal medium 1 and the host station 5 and/or by connecting the personal medium 1 to a corresponding port of the host station 5.

Preferably the authentication module A and the processing module C of a gateway process P are capable of being implemented in a memory region dedicated to the applications of a host station 5, and thus accessible in user mode from the random access memory of this host station 5. As a result these modules A and C may be written in a form that does not depend on the operating system of the host station 5, which may be any system, the gateway process P adapting its loading depending on the operating system detected at the host station 5. This detection may be carried out by means of a well-known command integrated in the gateway process P, for example the command “System.getProperty” of the JAVA® language.

The same is true in general of the filtering module D, which may be realised in a multicompatible form. In particular a personal medium 1 according to the invention may comprise a plurality of filtering modules D, each being compatible with one of the commonly-used operating systems (Windows®, UNIX®, LINUX® etc.).

The various user spaces may be recorded in mass storages of a plurality of different servers 9 of the host stations 5 and connected to the public digital network 10 to which these host stations 5 are themselves connected, in particular to the Internet. These different servers 9 consist at least in part of servers specific to the invention, but may for the most part consist of standard servers for providing data and/or information and/or programs via content providers on the corresponding network 10.

At least one of the servers, so-called central server 9a, is used to manage the information architecture and thus the information system according to the invention, in particular to manage various user accounts, in particular various identification data of the users of the information system according to the invention.

The user identification data recorded in the personal memory 2 of each personal medium 1 advantageously include on the one hand a code identifying individually a user, and on the other hand data identifying a central server 9a on the mass storage, of which the code identifying the user and other information relating to his/her user space may be stored. In particular the personal code (password) input by the user may be recorded, preferably in a form unreadable by humans and associated with the identification code of the user, on the corresponding central server 9a.

The authentication module A is thus capable of authenticating an authorised user by the inputting of the personal user code, in particular a user password, at a human-machine interface (in particular the keyboard 25 of the host station 5 to which the personal medium 1 is connected), and of storing this personal user code in the random access memory of the host station 5, so that this personal user code may then be communicated to each server 9 which the host station 5 wishes to access. Furthermore, the gateway process P, namely the processing module C, is also capable of transmitting the personal user code to each server 9 to which the host station 5 is connected, so as to transmit digital information between this server 9 and the host station 5 in one direction or the other.

FIG. 2 shows an example of implementation of a personal medium 1 in the form of a USB key comprising a unit 20 containing the personal memory 2 in the form of an electronic memory, and an interface 21 with a USB connection, the unit 20 carrying a male port 22 for such a USB connection. This male port 22 may be plugged into a corresponding female port 6 of a host station 5.

As shown in FIG. 2, the personal memory 2 comprises a region dedicated to the formation of the local cache 8, a region 23 containing the gateway process P in a form ready to be executed by any host station 5, and a region 24 containing configuration files of the host station 5. Among these configuration files the region 24 may include an AUTORUN.BAT file for the automatic startup of the gateway process P by the host station 5, an IP_PORT_SC.XML file containing the network address and the connection port of the central server 9a, a PCK.DATA file containing a central public key PCK serving for the encryption, as specified hereinafter, an LAK.DATA file containing a symmetric key LAK serving for the automatic encryption of the files, as specified hereinafter, a file ID_GENERATION_DATA enabling identification codes of files to be generated, as specified hereinafter, and a file ROOT_ID.XML containing a root file identifier ROOT_ID for the user, as specified hereinafter.

To start with, such a personal medium 1 is not personalised, that is to say does not contain the user identification data. Such a medium 1 may be distributed and marketed in a large volume at low cost. If a user acquires such a personal medium 1 and wishes to use it to access his/her user space, all the user has to do is connect it to a host station 5.

It should be noted that the gateway process P and the configuration files may be recorded beforehand (during manufacture) on the personal memory 2 of the personal medium 1. However, as an alternative, the personal media 1 may be supplied completely empty and all the information that they contain for the implementation of the invention, namely the gateway process P and the configuration files, may be remotely loaded on the personal memory 2, at the request of the user, from a remote server or from a fixed storage medium such as an optical disk. In a variant, only some of this information is recorded beforehand on the personal medium 1, during manufacture, the remainder of the information being remotely loaded.

As soon as the connection has been made the gateway process P is initiated by the host station 5, either automatically (if the operating system of the host station 5 permits the automatic initiation of such a process), or if necessary at the request of the user.

The operating system of the host station 5 then loads and carries out the gateway process P in user mode, and this gateway process P loads and implements the processing module C, which executes the following actions.

First of all the processing module C reads the network address of the corresponding central server 9a. It should be noted that, as an alternative, this network address may not be stored on the personal medium 1, but may be directly recorded in the code of the gateway process P itself, or on a specific server whose address is itself known by the gateway process P.

The processing module C is capable of creating each KEY file of the user space with an identifying record of this KEY file, so-called INFO_ID, comprising:
an identification code of the user who has created this KEY file,
a code identifying a server, so-called FILESERV_ID, where this KEY file was originally recorded and where it still remains recorded,
a digital code identifying individually the KEY file.

This INFO_ID record preferably includes in addition:
a code defining an encryption mode for the KEY file,
a code defining a synchronisation mode for the KEY file.

This type of designation of the KEY files in the user spaces that are common to all the user spaces and to all the operating systems and information technologies allows any KEY file whatsoever of the user space to be recorded and retrieved, irrespective of the site or the machine on which it is recorded, in a perfectly global manner.

The code identifying the user creating this KEY file in the INFO_ID record of a KEY file corresponds to the USER_ID code of this user.

The code FILESERV_ID identifying the server creating the file may uniquely consist of the network address of this server.

The digital code identifying individually the KEY file, so-called FILE_ID, is a number, for example of 64 bits. When the KEY file is created by the user, this code may be generated by the processing module C from the file ID_GENERATION.DATA recorded in the personal memory 2 of the personal medium 1. This file ID_GENERATION.DATA comprises an initial number that is increased at each creation of the KEY file by the processing module C.

The code defining the encryption mode for a KEY file can identify an encryption mode from among at least three encryption modes, namely: a total absence of encryption (the file is not encrypted and is accessible to the public); a manual encryption by means of which the contents of the file are encrypted by the host station 5 with a code specific to this KEY file that has to be input by the user, for example a password input by means of the keyboard (in this encryption mode the file is lost if the user loses this specific code); an automatic encryption by a symmetric key LAK generated by the processing module C from a pseudo-random code and encrypted with the personal user code when it is recorded in the LAK.DATA file on the personal memory 2. In this last case the KEY file is recorded on the local cache 8 of the personal medium 1 in encrypted form and is unencrypted during reading. It is thus propagated via the network in unencrypted form and is re-encrypted during a new writing.

Thanks to this automatic encryption process, the user can modify his/her personal user code without losing the files recorded on the local cache 8. In fact, during such a modification the said symmetric key LAK, once it has been unencrypted with the old personal user code, is encrypted with the new personal user code and then recorded in the thereby encrypted form on the personal memory 2. This symmetric key LAK is created and recorded in the personal memory 2 as soon as the user inputs for the first time his/her personal code in order to create his/her personal user account.

The code defining the synchronisation mode of a KEY file can specify the way in which this KEY file is synchronised, that is to say updated. Two synchronisation modes at least are possible, namely the synchronised mode and the non-synchronised (or remote) mode.

In the synchronised mode, when a KEY file corresponding to an INFO_ID is read, if this KEY file is present in the local cache 8 of the personal memory 2 and if it is updated in this local cache 8, then the KEY file is read from the cache. If on the other hand the KEY file is not present in the local cache 8 or has not been updated in this local cache 8, the reading takes place from the server on which the KEY file is recorded. It is then written on the local cache 8 of the personal memory 2.

During a reading of a KEY file, this KEY file is always written into the local cache 8 of the personal memory 2. The processing module C includes in addition an updating management sub-module that enables the files recorded on the servers 9 to be regularly updated according to predetermined time intervals or according to a process known per se.

In the non-synchronised or remote mode, the KEY files are recorded solely on the servers 9 and are never recorded in the local cache 8 of the personal memory 2 of the personal medium 1. During a reading the KEY file should be read from the server 9 on which it is recorded. During a writing the KEY file is directly and solely written on the server 9, the updating management sub-module not being convenient in this case. This synchronisation mode in which the files are not synchronised is used for the password files or specific command files or KEY files defined as such by the user. The synchronised mode is on the other hand used for the majority of the other KEY files of the user space and enables in particular the changes made by a user on the KEY files to be saved, even in the event of a sudden interruption in the network connection or of the connection between the personal medium 1 and the host station 5.

In the subsequent stage the processing module attempts to read a root file identifier designated ROOT_ID, in the ROOT_ID.XML file recorded on the personal memory 2. The identifier of the root file ROOT_ID is constructed just like any identifier INFO_ID, with the identification code of the user USER_ID and the code SERVER_ID identifying the server 9 on which this root file is recorded. When used for the first time the file ROOT_ID.XML containing the identifier ROOT_ID does not appear on the personal memory 2. In this case the processing module C asks the user if a new account should be created and, if in the affirmative, establishes a connection with the central server 9a and requests this central server 9a to prepare a new user with a user identification code designated USER_ID.

The processing module C then asks the user to input a personal user code (password) of his/her choice. The personal user code input for example on the keyboard 25 of the host station 5 is then stored by the processing module C in the random access memory 26 of the host station 5, in a data storage region 27 of this random access memory 26.

After having received the user identification code USER_ID of the central server 9a, the processing module C asks for confirmation from the human user, then chooses an available server 9, creates a root file identifier ROOT_ID (with the user code USER_ID and the code SERVER_ID of the selected server) and returns the confirmation consisting of the entered personal user code (password) and the identifier ROOT_ID thereby created.

Before passing these data to the central server 9a, the processing module C carries out an encryption of at least the personal user code and, preferably, of all these data transmitted to the central server 9a. To this end the processing module C is capable of generating a symmetric key CS from a pseudo-random code supplied by a generator of pseudo-random codes. This symmetric key CS then serves for the encryption of the data during their transmission between the servers 9 and a host station 5, as a general rule, and this thanks to an encryption sub-module incorporated in the processing module C. The public encryption key PCK stored in the configuration file PCK.DATA in the personal memory 2 (initially during manufacture or by remote loading) is an asymmetric public encryption key corresponding to a private key that is itself stored on the central server 9a. The processing module C is then capable of encrypting the symmetric key CS with this public key PCK, transmitting this thereby encrypted symmetric key to the central server 9a, which is itself adapted to unencrypt this symmetric key with the corresponding asymmetric private key, and of encrypting the root file identifier ROOT_ID and the personal user code with this symmetric key CS, and this before transmitting them to the central server 9a.

The central server 9a receiving the user identification data creates a user account, and then returns a command to the processing module C so that the latter records the root file identifier ROOT_ID in the file ROOT_ID.XML on the personal memory 2 of the personal medium 1.

Once this operation has been carried out during the first connection, the personal medium 1 is configured so that it can be used by a predetermined human user (or a group of human users possessing the same user identification code USER_ID).

During a new connection of the personal medium 1 to any host station 5, the authentication module A again asks the human user for the personal user code, which the user can input via the keyboard 25 and/or the corresponding screen, and/or by any other means (for example by voice input).

The personal code input by the user is then verified by the authentication module A. If the personal code is not correct, the user is refused access. If on the other hand the personal code agrees with that recorded in the central server 9a, access is authorised. Each time a connection is made to a server 9 possessing the symmetric private key corresponding to the public key PCK so that this server authorises access to the files of the user space present in its mass storage, a symmetric key CS is generated by the processing module C, encrypted with the public key PCK, then the USER_ID user code of the authenticated user and his/her personal user code are encrypted with this symmetric key CS, following which the whole (the symmetric key CS encrypted with the public key PCK, the user code USER_ID and the personal code encrypted with the symmetric key CS) is sent to the contacted server 9. The latter unencrypts the symmetric key CS with the private key corresponding to the public key PCK, next unencrypts the user code USER_ID and the personal code with the symmetric key CS, and then verifies the validity of the user by verifying the personal code corresponding to the user code USER_ID. This verification is carried out directly by a central server 9a; if the server 9 is not a central server, it contacts a central server so that the latter can authenticate the user.

The set of data that are subsequently transmitted by this established connection may be advantageously encrypted with the symmetric key CS so that they cannot be analysed by a rogue user of the network 10.

It should be noted that this technique takes account of the fact that a symmetric encryption is much faster than an asymmetric encryption: this is why only the symmetric key CS is encrypted in an asymmetric manner. In the same way, the data transmitted by the server 9 and received by the host station 5 may be encrypted with the symmetric key CS.

In the case where the user has successfully been authenticated by the authentication module A and access to the user space corresponding to the identification data of the connected personal medium 1 has been authorised, the gateway process P carries out a configuration of the host station 5 so that the latter can access the KEY files of the user space, and this in accordance with the stages shown in FIG. 4. During the first stage 41, after the gateway process P has detected the operating system of the host station 5 to which the personal medium 1 is connected, the filtering module D compatible with the detected operating system is loaded into the random access memory of the host station 5. In the following description an example of implementation is given of the filtering module D compatible with an operating system of the type Windows®, for example Windows XP®. This filtering module D includes a runtime library incorporating the functions of the operating system that are necessary for the filtering and processing of requests for files.

During the subsequent stage 42, the filtering module D initiates the process for establishing the list of the machines present on the local network of the host station 5, and then adds a local machine corresponding to the name of the personal medium 1, for example CLE_XX, to this list of machines on the local network of the host station 5.

In the subsequent stage 43 the filtering module D loads into the random access memory of the host station 5 a processing task for dealing with requests for the machine CLE_XX, which task is then carried out permanently and is described in more detail hereinafter.

In the next stage 44 the filtering module D searches in the list of the virtual disk of the host station 5 for a free virtual disk drive formatted as U:. For example, the filtering module may start such a search from the last disk drive, namely from Z:. The filtering module D then combines this virtual drive with a file access path of type \\CLE_XX\AAA\, the alphabetical grouping AAA being defined by default by the filtering module D.

Following the stage 44, the host station 5 is configured so as to be able to deal with requests for files of the virtual disk U: corresponding to the user space of the authorised user of the personal medium 1.

FIG. 5 shows in detail the stage 43 for processing requests by the filtering module D.

During the stage 51 the filtering module D is placed in the blocking read state by a known function (for example “Netbios” under Windows®). In this state the filtering module is waiting for a reading of a request arriving at the machine \\CLE_XX.

The subsequent stage 52 corresponds to the arrival of a request for the machine \\CLE_XX, as detected by the filtering module D. The latter then initiates an SMB/CIFS interpretation stage 53 for interpreting the request in order to translate it according to a protocol adapted to the processing module C.

In the subsequent stage 54 the filtering module D calls up a function corresponding to the request for its treatment by the processing module C. The subsequent stage 55 corresponds to the execution of this function by the processing module C and will be described in more detail hereinafter.

The filtering module D is then placed in a situation of waiting for the response from the function carried out by the processing module C, and this during the stage 56. When this response is received by the filtering module D the latter forms the packet of octets (8-bit bytes) corresponding to this response during the stage 57, according to the protocol (CIFS in the Windows® example) corresponding to the operating system of the host station 5. In the subsequent stage 58 the filtering module D returns the reply corresponding to the request and coming from the machine \\CLE_XX. This reply is also a known system function incorporated in “Netbios”. After the stage 58 the filtering module D returns to the blocking read state of the initial stage 51.

In a variant that is not shown, the filtering module D may be implemented in the form of a module of structure similar to that of a peripheral pilot, and capable of being able to be inserted into the kernel of the operating system in the random access memory and of being able to receive directly the requests relating to the virtual disk U:.

It should be noted that, according to the invention, the architecture of the various directories and KEY files of each user may be organised in a standard way in the form of a tree, and this architecture is stored in the root file identified by ROOT_ID on a server 9 (and not on the personal medium 1 or on a host station 5). In addition, each KEY file is identified in this architecture by its access path and, moreover, by the corresponding identifier INFO_ID as described above.

FIGS. 6, 7 and 8 illustrate the various stages carried out by the processing module C in order to perform various functions that may be carried out on KEY files, namely reading of a file, writing onto a file and the creation of a new file.

FIG. 6 shows by way of example a reading of a KEY file belonging to a designated user USER1 and whose access path is USER1\DIR1\FFF1. In a first series of steps 60 the processing module C determines the architecture of the user space of USER1. To do this, the processing module C searches the contents of the root file of USER1. In order to know the identifier ROOT_ID1 of the root file of the user USER1, if the connected authorised user is not USER1, the processing module C asks the central server 9a during the stage 61 via the network for this identifier ROOT_ID1. On the other hand, if USER1 is the connected authorised user, ROOT_ID1 can be read directly during this stage 61 in the file ROOT_ID.XML of the personal medium 1 of USER1. In the subsequent stage 62 the processing module C reads, in the identifier ROOT_ID1, the identifier SERVER_ID1 of the server 9 where this root file is recorded, and then during the stage 63 the processing module C reads the architecture contained in this root file identified by ROOT_ID1, in the server SERVER_ID1 that contains it or in the local cache 8, which enables the identifier INFO_ID1 of the file DIR1\FFF1 to be known by association during the stage 64. The processing module C can then read the contents of this file INFO_ID1 during the stage 65.

It should be noted that all the requests for information (request for identifier, reading the file contents, request to write the contents of a file) to a server 9 are made by any known technique for transferring information on the network 10 (for example a specific bilateral network connection (“socket”)), to which is applied the protocol for encrypting sent and received information as described above, the information being encrypted with a symmetric key CS, which is itself encrypted with the asymmetric public key PCK.

During a writing (FIG. 7) on a KEY file of the user USER1 whose access path is USER1\DIR1\FFF2, the processing module C also determines, as previously, the architecture of the files of the user space of USER1, by executing the series of preliminary stages 60 described above. The processing module C then searches during the stage 71 for the identification code INFO_ID2 of the file corresponding to DIR1\FFF2.

After having found the record INFO_ID2 identifying the file DIR1\FFF2 uniquely and unambiguously, the stage 72 consists in writing this file. In the case of a synchronised type file, this writing takes place in the local cache 8 of the personal medium 1, following which the updating management sub-module is initiated during the stage 73 by the processing module C in order to update this file where necessary.

FIG. 8 shows a process for the creation of a new KEY file of the user USER1, whose access path is USER1\DIR1\FFF3.

The preliminary stages 60 described above are first of all carried out, enabling the architecture of the files of the user space of USER1 to be read. In the subsequent stage 81 the processing module C creates a new identifier corresponding to this new file DIR1\FFF3, that is to say an identifier designated INFO_ID3. In the next stage 82 this new record INFO_ID3 is added to the contents of the user space USER1 with a specified name (in this case DIR1\FFF3). The processing module C next writes during the stage 83 the new version of the files architecture of this user in the local cache 8 of the personal medium 1, and then initiates during the stage 84 the updating management sub-module, which enables this file to be updated on the corresponding central server 9a at any appropriate time.

In order to facilitate the functioning of the updating management sub-module, a specific file may be provided that is stored in the local cache 8 of the personal memory 2, in which are recorded the information identifying the various KEY files that have been modified by the user and then have to undergo a verification of the updating by the updating management sub-module.

In addition, during the creation of a new KEY file, in order to find out on which server 9 this new file should be recorded, the processing module C can consult in the central server 9a a file identifying the various servers and in which the level of occupancy of each server 9 is stored in real time. It should be noted in this regard that the various servers 9 may themselves be identified in an information system according to the invention as specific users, that is to say in a manner strictly identical to the personal media 1 from the logic point of view. Thus, their network address may be stored in a specific file of their mass storage and updated by synchronisation in the same way as the files of the local cache 8 of a personal medium 1.

Any KEY file of the user space that is subject to a digital processing by the host station 5 is by default recorded in the local cache 8 of the personal memory 2. Of course, the user can nevertheless prevent such a writing in the local cache 8, for example by specifying that the file is of the non-synchronised type. There is then the risk that this file may be lost if the connection to the network or the connection between the personal medium 1 and the host station 5 is suddenly interrupted.

The updating management sub-module establishes whether an updating is necessary by consulting the metadata associated with each file, in particular the date of the last modification carried out on the file. Such an updating management sub-module is known per se and is not described in detail.

The invention thus represents a considerable advance and a radical change in methods of working with information systems. Thus, the users can, thanks to the invention, manage all their data and personal or personalized information, not only on a portable medium that contains this information or from their own dedicated workstation containing this information, but remotely via a network such as the (public) Internet, and this due uniquely to a personal medium 1 that enables the data and information to be identified reliably and that saves the files during the course of modification for the purposes of a synchronisation, and moreover from any standard host stations 5 to which they may be connected and which are automatically configured by the personal medium 1.

It should be noted that the information of the user space is never recorded on the mass storage of a host station 5. Even though the various files and the various information contents of each user space may be propagated among a very large number of servers 9 on the network, each user views his/her user space transparently as a directory of the host station 5 to which he/she is connected and accesses the corresponding KEY files in a conventional way, as if these files were stored on the mass storage of the host station 5. Moreover, access by reading/writing or creation of new files is carried out in a perfectly reliable and secure way.

If a personal medium 1 is lost or stolen, all the user has to do is to obtain a new personal medium 1, and if necessary to supply it with the gateway process P and configuration files by remote loading. In this case the gateway process P will not find the file ROOT_ID.XML, and will ask the user to choose between creating an account or restoring an account. In the case where an account is restored the user inputs his/her code USER_ID and his/her personal user code, which are transmitted to the central server 9a. The central server verifies their validity and returns the root file identifier ROOT_ID of this user, who may then access his/her user space again.

The invention not only allows data to be accessed, but also makes available to the various users programs and specific applications that are automatically updated by the providers of these programs and specific applications, without the user himself/herself having to remotely load these updates or to install these updates on any computer. In fact, a software consisting of executable files can be recorded on the user space of the editor of this software. This user space is made accessible either free of charge or subject to a subscription to a specific service by any client user wishing to access it. These files constituting the software are subsequently loaded directly into the random access memory of the host station 5 to which the personal medium 1 of the client user is connected and executed at the host station 5 without the client user having to carry out any installation procedure.

The invention also enables in the same way software locations or software updating or specific data to be provided according to the users, and allows the payments of the various users to be managed so that they can access this specific software or updates or data. The invention allows each user to make use of all his/her user space, and moreover from any site, permanently and in a perfectly reliable and synchronised manner. The result of this is also that the users will not be inclined to acquire software or data illegally, since they have not had to instal them themselves.

The invention allows in particular the access to various information and common or individually personalised data and programs to be managed reliably and flexibly by the various users or groups of users. In fact, it is possible for an authenticated user to allow access to his/her user space by other authenticated users by configuring the servers 9 so that they authorise access to this user space to these other users.

The invention may be the subject of numerous applications for the storage and making available of information and various types of personal data such as software, wordprocessing documents, tables, calendars, Internet favorites or others.

In an information system according to the invention, the various files are identified by the INFO_ID records, which always remain the same during the life of the file and do not depend on the operating systems and recording technologies. The names of files are thus always valid at all times regardless of the technological platforms that are implemented and used on the servers and/or the host stations 5.

The various servers 9 used to store the files require only a very small digital processing capacity in actual fact restricted to the recording and reading of the various files. These are thus basically mass storages and, in contrast to the hitherto known standard information architectures, in an information system according to the invention the information processing is entirely delegated to the host stations 5 and not to the servers themselves. The result is that the various servers 9 are machines that can be extremely light and in which the interfaces between the host stations 5 and the various servers 9 are particularly simple since they only involve actions to do with the files and not the folders and directories. Furthermore, consistency between the local caches 8 and the host stations 5 and the personal media 1 is ensured.

The invention involves a complete change in the customs and procedures associated with the use of information data.

It is no longer necessary to install software since this is accessible as soon as it is present in its directly executable form on the user space of an editor user and is made accessible to the client users wishing to use it. The client user operates the software when necessary, on request (one direct way being for example to double click on the icon representing the software) and from any host station 5 to which his/her personal medium 1 is connected, without having to carry out any procedures to install the software on the host station 5.

By virtue of the invention software can be adapted to a client without having to be modified by the client himself/herself. The software can read configuration files on the user space on which it is recorded (user space of the editor) but it can just as well read supplementary configuration files on the user space of the client user executing it. In this way, for example, a software can change its graphical appearance on a file of the client user space of the user and, for example if the user is partially-sighted, change the colours to his/her preference.

An Internet site can, in the same way, adapt its appearance without having to ask for and record the preferences of the users in a database belonging to this Internet site. It is sufficient for this purpose to read a file (for example a file of CSS (Cascading Style Sheet) pages) on the user space of the user visiting this site.

The KEY files of the users are not duplicated on all the stations where they have to be used, but are accessible in a simple and global manner on request (for example by double clicking on the icon representing them). It is thus not necessary to exchange the files by transferring them manually from station to station or by transmitting them by electronic mail. The quality of use of the files is improved since the end user no longer has to accept them, nor receive a file when a sender user transmits such a file to the end user. It is sufficient for the end user to access this file only when he/she actually needs it.

The data generated by the use of information sources (documents, correspondence, contacts, software, images, music, various digital creations, Internet sites, databases, etc.) are classified as a whole and are accessible in a simple and direct manner by the user without the data being subject to the disadvantages associated with their storage on a single station (possible damage or destruction of the station, dependence of the data on the operating system present on the station, restrictions on the recording space, etc.). The invention thus provides a universal access to the data from any host station 5 to which the user connects his/her personal medium 1.

The invention is thus based on a clear separation between the recording and interpretation of the data. The fact that the data are interpreted according to the host stations increases the utilisation potential of the data. For example, an address book managed on a personal computer type host station will be able to be classified and completed very easily by means of the keyboard and the mouse of the said host station. A user will also be able to utilize this address book on a mobile phone type host station if the user connects his/her personal medium to the latter, thereby enabling the mobile phone to recognise numbers useful to this user, and this regardless of the type or owner of the mobile phone as such. In the same way, a user will be able to store his/her preferred radio stations by connecting his/her personal medium to a living room hi-fi channel type host station and then listen to the radio stations by connecting his/her personal medium to a car radio type host station, or also to a more sophisticated type of host station such as an interactive receiver equipped with headphones.

By recording the data on a device different to the host stations where the data are interpreted, the invention enables multiple points of access to a user space to be created. Instead of being grouped in a personal computer that carries out all the tasks, the functionalities are instead present everywhere where the user needs them, each of the multiple stations then being capable of interpreting at least part of the data of the user.

As examples of other applications of the invention, a housewife's shopping list may be interpreted by a refrigerator (host station) when she goes to the refrigerator equipped with her personal medium identifying her. The refrigerator can thus calculate what items are required or even suggest a recipe depending on the family's preferences that have been recorded beforehand on a domestic personal website.

The lighting, heating and functioning of appliances/units can be adapted in a living or working environment depending on the user(s) who is/are present.

Furthermore, even when away from his/her base, a user can share a specific file of his/her user space interpreted by an entry door type of host station, for example the door of his/her house, with another user so that the latter can enter the same building (house), the door allowing in this way access to the other user when the latter connects his/her personal medium.

The invention enables the increasing importance of information processing technologies in contemporary living to be taken into account, and enables the problem of the current growing complication for users of the known systems to be alleviated: their data are dispersed (servers, personal computers, mobile phones, etc.), are in different formats (for example it is difficult to save a mobile phone address book on a personal computer) and are difficult to access (one must own and have available the digital machine enabling the data to be interpreted).

With the invention the information of the user spaces is clearly and easily accessible, is independent of the executing host stations, always synchronised (updated), and yet is recorded and distributed to the servers, which means that the quality and durability of the recording are greatly superior to those obtained with personal computers.

The invention also enables the servers 9 to carry out a continual saving process, allowing the data of the user spaces to be preserved in a secure manner over the long term.

The invention may be the object of numerous variants of implementation and other applications that have been described above and with reference to the drawings. In particular, other filtering modules D compatible with operating systems other than WINDOWS® may be implemented in a similar way to the example given above, and incorporated into the gateway process P.

The information functionalities, architectures and structures described above may be implemented by simple programming of known information devices, in particular for example with the aid of the JAVA language, enabling a program to be written in a way that does not depend on the operating system, which is particularly useful in the case of the processing module C.

1. A portable personal mass storage medium, so-called personal medium comprising:
at least one mass storage, so-called personal memory,
means for connection to any information station, so-called host station, equipped with
digital processing means involving microprocessor(s) and associated random access memory(ies),
at least one file operating and management system,
connection means corresponding to those of the personal medium, so that at least a part of the personal memory of the personal medium can be accessed by reading/writing by a host station when the connection means are active,
data, so-called user identification data, recorded in said personal memory, for identifying at least one human user, so-called authorised user, who is authorised to use this personal medium,
wherein it includes, recorded in said personal memory, data forming a process, so-called gateway process (P), capable of being loaded in random access memory of a host station to which the personal medium is connected, this gateway process (P) comprising:
an authentication module (A) capable of enabling any host station to authenticate any human user making the connection of the personal medium to this host station, said authentication module being capable of determining whether said human user is an authorised user, and of authorising access to a user space corresponding to the user identification data recorded in the personal memory only if an authorised user is identified and authenticated, said user space comprising digital information recorded in a part, so-called local cache, of said personal memory and/or in at least one mass storage of at least one server distinct from said host station and to which said host station, provided with connection and access means to at least one digital network, may be connected via such a network,
a file request filtering module (D), capable of recognising any request involving at least one file, so-called KEY file, belonging to said user space of said authorised user,
a processing module (C) for processing each request involving a KEY file, and capable of creating a KEY file and/or accessing any KEY file and permitting the processing of a corresponding request by the file operating and management system of said host station in the same way as if it were a request involving a file belonging to said host station.

2. A personal medium as claimed in claim 1, wherein it is free of digital processing means other than those that are necessary, where appropriate, for the setting up and functioning of the connection means to any host station.

3. A personal medium as claimed in claim 1, wherein it is free of a human-machine interface.

4. A personal medium as claimed in claim 1, wherein said connection means to a host station are of the type being active by bringing together and/or connecting up the personal medium and the host station.

5. A personal medium as claimed in claim 1, wherein said connection means to a host station are capable of permitting the setting up of a universal serial bus (USB).

6. A personal medium as claimed in claim 1, wherein said processing module (C) is capable of being implemented in a memory region dedicated to application softwares and accessible in a user mode of the random access memory of a host station.

7. A personal medium as claimed in claim 1, wherein said authentication module (A) is capable of authenticating an authorised user by the latter's inputting, at a human-machine interface, a code, so-called personal user code, allowing the validation of the identity of the user by the authentication module (A), and of storing said personal user code in the random access memory of said host station, and wherein said gateway process (P) is capable of transmitting said personal user code to each server to which said host station is connected for transmitting digital information.

8. A personal medium as claimed in claim 1, wherein said user identification data recorded in said personal memory comprise:
a code individually identifying a user,
data identifying a central server.

9. A personal medium as claimed in claim 7, wherein said processing module (C) includes at least one encryption sub-module for encryption by a symmetric key LAK generated by said processing module (C) from a code supplied by said processing module (C).

10. A personal medium as claimed in claim 7, wherein it comprises an asymmetric public encryption key PCK, recorded in said personal memory, corresponding to a private key of a central server stored in a mass storage of said central server, and wherein said processing module (C) is capable of:
generating a symmetric key and encrypting the latter with said public key,
transmitting this encrypted symmetric key to a central server, which is itself capable of unencrypting it,
encrypting said user identification data and said personal user code with said symmetric key before transmitting them to the central server.

11. A personal medium as claimed in claim 1, wherein said processing module (C) is capable of recording by default in said local cache of said personal memory, any KEY file of said user space that is the subject of a digital processing by said host station.

12. A personal medium as claimed in claim 1, wherein said processing module (C) is capable of creating each KEY file with an identifying record of this KEY file, so-called INFO_ID, comprising:
a code identifying a server, so-called FILESERV_ID, where this KEY file was initially recorded,
a code identifying a user who has created this KEY file,
a digital code individually identifying the KEY file.

13. A personal medium as claimed in claim 12, wherein an INFO_ID record includes in addition:
a code defining an encryption mode for the KEY file,
a code defining a synchronisation mode for the KEY file.

14. A personal medium as claimed in claim 12, wherein it comprises, recorded in said personal memory, a file, so-called ID_GENERATION.DATA file, containing data capable of permitting said processing module (C) to generate digital codes individually identifying the KEY files created by said user.

15. A personal medium as claimed in claim 1, wherein it comprises, recorded in said personal memory, ROOT_ID data identifying at least one root file recorded on a server, in which at least a part of the architecture of the KEY files of the user space is recorded.

16. An information system with secure access to a network by users, comprising:
information stations, so-called host stations, each provided with:
digital processing means involving digital microprocessor(s) and associated random access memory(ies),
at least one file operating and management system,
connection means corresponding to connection means of at least one portable mass storage medium, so-called personal medium, in such a way that at least part of mass storage of said personal medium can be accessed by reading/writing by said host station when said connection means are active,
connection and access means to at least one public digital network,
at least one server comprising at least one mass storage, so-called server memory, and connection means to at least one public digital network, and capable of permitting access by reading/writing to at least a part of this server memory via such a public digital network,
each personal medium comprising:
at least one mass storage, so-called personal memory,
connection means to any host station,
data, so-called user identification data, recorded in said personal memory, for identifying at least one human user, so-called authorised user, who is authorised to use this personal medium,
wherein each personal medium comprises, recorded in said personal memory, data forming a process, so-called gateway process (P), capable of being loaded in random access memory of a host station to which the personal medium is connected, this gateway process (P) comprising:
an authentication module (A) capable of enabling any host station to authenticate any human user making a connection from this personal medium to this host station, and capable of determining whether said human user is an authorised user, and of authorising access to a user space corresponding to the user identification data recorded in the personal memory only if an authorised user is identified and authenticated, said user space comprising digital information recorded in a part, so-called local cache, of said personal memory and/or in at least one server memory of at least one server distinct from the host station,
a file request filtering module (D), capable of recognising any request involving at least one file, so-called KEY file, belonging to said user space of the authorised user,
a processing module (C) for processing each request involving a KEY file, capable of creating a KEY file and/or accessing any KEY file and permitting the processing of a corresponding request by the file operating and management system of the host station in the same way as if it were a request involving a file belonging to this host station.

17. An information system as claimed in claim 16, wherein said personal media are free of digital processing means other than those necessary, where appropriate, for the setting up and functioning of the connection means between said personal media and said host stations.

18. An information system as claimed in claim 16, wherein said personal media are free of a human-machine interface, and wherein said host stations are provided with a human-machine interface.

19. An information system as claimed in claim 16, wherein the connection means for connecting a personal medium to a host station are of the type being active by bringing them together and/or connecting the personal medium to the host station.

20. An information system as claimed in claim 16, wherein said connection means for connecting a personal medium to a host station are capable of permitting the setting up of a universal serial bus (USB).

21. An information system as claimed in claim 16, wherein said processing module (C) is capable of being implemented in a memory region dedicated to application softwares and is accessible in a user mode of the random access memory of a host station.

22. An information system as claimed in claim 16, wherein said authentication module (A) is capable of authenticating an authorised user by the user's inputting a code, so-called personal user code, at a human-machine interface, permitting the validation of the identity of the user by the authentication module (A), and of storing said personal user code in the random access memory of said host station, and wherein said gateway process (P) is capable of transmitting said personal user code to each server to which said host station is connected for transmitting digital information.

23. An information system as claimed in claim 22, wherein each server is capable of verifying the validity of said personal user code before authorising the setting up of a link between a server and a host station to which a corresponding personal medium is connected.

24. An information system as claimed in claim 22, wherein it comprises at least one server, so-called central server, containing for each user at least one record, so-called user account, containing said user identification data associated with said personal user code which is stored in said record in a form that cannot be understood by a person.

25. An information system as claimed in claim 24, wherein said user identification data recorded in said personal memory of a personal medium comprise:
a code individually identifying a user,
data identifying a central server.

26. An information system as claimed in claim 22, wherein said processing module (C) includes at least one encryption sub-module for encryption by a symmetric key LAK generated by said processing module (C) from a code supplied by said processing module (C).

27. An information system as claimed in claim 22, wherein each personal medium comprises, recorded in said personal memory, a public asymmetric encryption key corresponding to a private key of a central server stored in a mass storage of said central server, and wherein said processing module (C) is capable of:
generating a symmetric key and encrypting it with said public key,
transmitting this encrypted symmetric key to the central server, which is itself capable of unencrypting it,
encrypting said user identification data and said personal user code with said symmetric key before transmitting them to the central server.

28. An information system as claimed in claim 16, wherein said processing module (C) is capable of recording by default, in said local cache of said personal memory of said personal medium, any KEY file of said user space that is the subject of a digital processing by said host station.

29. An information system as claimed in claim 16, wherein said processing module (C) is capable of creating each KEY file with an identifying record of this KEY file, so-called INFO_ID, comprising:
a code identifying a server, so-called FILESERV_ID, where this KEY file was initially recorded,
a code identifying a user who has created this KEY file,
a digital code individually identifying the KEY file.

30. An information system as claimed in claim 29, wherein an INFO_ID record includes in addition:
a code defining an encryption mode for the KEY file,
a code defining a synchronisation mode for the KEY file.

31. An information system as claimed in claim 16, wherein it comprises, recorded in said personally memory of each personal medium, a file, so-called ID_GENERATION.DATA file, containing data capable of allowing said processing module (C) to generate digital codes individually identifying the files created by said user of said personal medium.

32. An information system as claimed in claim 16, wherein it comprises, recorded in said personal memory of each personal medium, ROOT_ID data identifying at least one root file recorded on a server, said root file containing at least a part of the architecture of the KEY files of said user space.

33. An information system as claimed in claim 16, wherein said host stations are chosen from:
fixed personal computers,
portable personal computers,
portable digital processing devices.
